(19) United States
(12) Patent Application Publication
(10) Pub. No.: US 2012/0312096 A1
(43) Pub. Date: Dec. 13, 2012

(54) INERTIAL SENSOR

(75) Inventors: Won Kyu Jeung, Gyunggi-do (KR); Jung Won Lee, Gyunggi-do (KR)

(73) Assignee: SAMSUNG ELECTRO-MECHANICS CO., LTD., Gyunggi-do (KR)

(21) Appl. No.: 13/479,522

(22) Filed: May 24, 2012

(30) Foreign Application Priority Data
Jun. 8, 2011 (KR) 1020110055283

(51) Int. Cl. G01P 15/02

(52) U.S. Cl. 73/514.01

(57) ABSTRACT

Disclosed herein is an inertial sensor. The inertial sensor 100 according to a preferred embodiment of the present invention includes a membrane including wiring layers that are partitioned into insulating regions and conducting regions, a mass body provided under a central portion of the membrane, and a post provided under an edge of the membrane so as to support the membrane and surrounding the mass body. By this configuration, the membrane is formed as a chief metal core, thereby making it possible to reduce the total manufacturing cost of the inertial sensor and the parasitic capacitance is reduced, thereby making it possible to improve sensitivity of the inertial sensor. Further, the mass body extending from the membrane is made of metals to increase a mass density of the mass body, thereby making it possible to improve the sensitivity of the inertial sensor.

### CROSS REFERENCE TO RELATED APPLICATION

This application claims the benefit of Korean Patent Application No. 10-2011-0055283, filed on Jun. 8, 2011, entitled “Inertial Sensor”, which is hereby incorporated by reference in its entirety into this application.

### BACKGROUND OF THE INVENTION

1. Technical Field

The present invention relates to an inertial sensor.

2. Description of the Related Art

Recently, an inertial sensor has been used in various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The inertial sensor generally adopts a configuration in which a mass body is adhered to an elastic substrate such as a membrane, or the like, in order to measure acceleration and angular velocity. Through the configuration, the inertial sensor may calculate the acceleration by measuring inertial force applied to the mass body and may calculate the angular velocity by measuring Coriolis force applied to the mass body.

In detail, a process of measuring the acceleration and the angular velocity by using the inertial sensor will be described in detail below. First, the acceleration may be implemented by Newton's law of motion “F=ma”, where “F” represents inertial force applied to the mass body, “m” represents a mass of the mass body, and “a” is acceleration to be measured. Among others, the acceleration a may be obtained by measuring the force F applied to the mass body and dividing the measured force F by the mass m of the mass body that is a predetermined value. Meanwhile, the angular velocity may be obtained by Coriolis force “F=2MΩ·v”, where “F” represents the Coriolis force applied to the mass body, “m” represents the mass of the mass body, “Ω” represents the angular velocity to be measured, and “v” represents the motion velocity of the mass body. Among others, since the motion velocity v of the mass body and the mass m of the mass body are values that are known in advance, the angular velocity Ω may be obtained by measuring the Coriolis force (F) applied to the mass body.

As such, in order to measure the acceleration and the angular velocity, the inertial sensor needs to include the mass body and the membrane vibrating the mass body. In this connection, the inertial sensor according to the prior art forms the membrane and the mass body by selectively etching a silicon on insulator (SOI) substrate. However, the SOI substrate is expensive, which results in increasing the total manufacturing cost of the inertial sensor. In addition, the SOI substrate relatively reduces a mass density of the mass body and reduces the sensitivity of the inertial sensor due to the occurrence of parasitic capacitance.

### SUMMARY OF THE INVENTION

The present invention has been made in an effort to provide an inertial sensor capable of reducing manufacturing costs by forming a membrane as a metal core, increasing a mass density of a mass body, and improving sensitivity by reducing parasitic capacitance.

According to a preferred embodiment of the present invention, there is provided an inertial sensor, including: a membrane including wiring layers that are partitioned into insulating regions and conducting regions; a mass body provided under a central portion of the membrane; and a post provided under an edge of the membrane so as to support the membrane and surrounding the mass body.

The membrane may be provided with electrodes and pads electrically connected to the electrodes and provided at the edge of the membrane, wherein the pads are electrically connected to through holes penetrating through the membrane and the post.

The through holes may penetrate through the insulating regions of the membrane.

A bottom portion of the post may be provided with an integrated circuit and the through holes may be connected to the integrated circuit.

The membrane may be provided with electrodes and the electrodes may be electrically connected to the through holes that penetrate through the post through the conducting region.

A bottom portion of the post may be provided with an integrated circuit and the through holes may be connected to the integrated circuit.

The conducting regions may be made of metals and the mass body may be formed by extending downwardly of the membrane from the conducting region.

Both surfaces of the wiring layers may be provided with insulating layers.

The wiring layers may be stacked in a multi-layer and insulating layers may be formed between the wiring layers stacked in a multi-layer.

The wiring layers may be partitioned into the insulating regions and the conducting regions by selectively anodizing a metal core by an anodizing process.

The metal core may be made of any one of aluminum (Al), nickel (Ni), magnesium (Mg), titanium (Ti), zinc (Zn), and tantalum (Ta).

The post may be made of silicon or polymer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view of an inertial sensor according to a first preferred embodiment of the present invention;

FIG. 2 is a cross-sectional view of the inertial sensor shown in FIG. 1 taken along line A-A′;

FIG. 3 is a cross-sectional view of the inertial sensor shown in FIG. 1 taken along line B-B′;

FIG. 4 is a cross-sectional view of the inertial sensor shown in FIG. 3 with which an integrated circuit, a printed circuit board, and a metal cap are combined;

FIG. 5 is a plan view of an inertial sensor according to a second preferred embodiment of the present invention;

FIG. 6 is a cross-sectional view of the inertial sensor shown in FIG. 5 taken along line C-C′; and

FIG. 7 is a cross-sectional view of the inertial sensor shown in FIG. 6 with which an integrated circuit, a printed circuit board, and a metal cap are combined.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

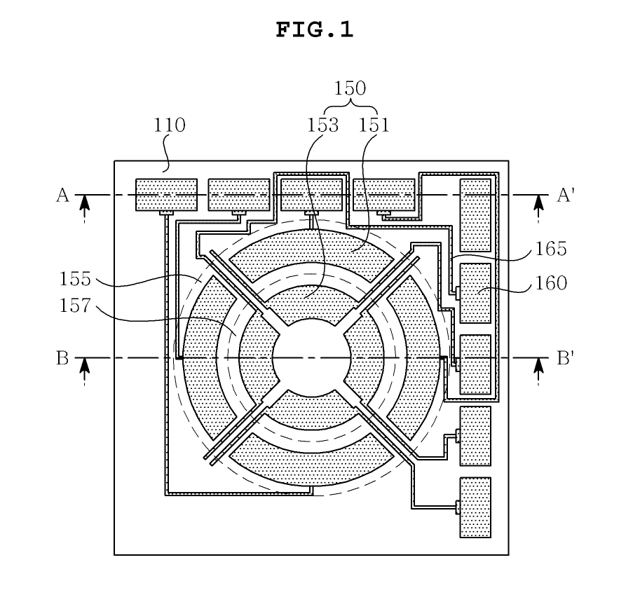

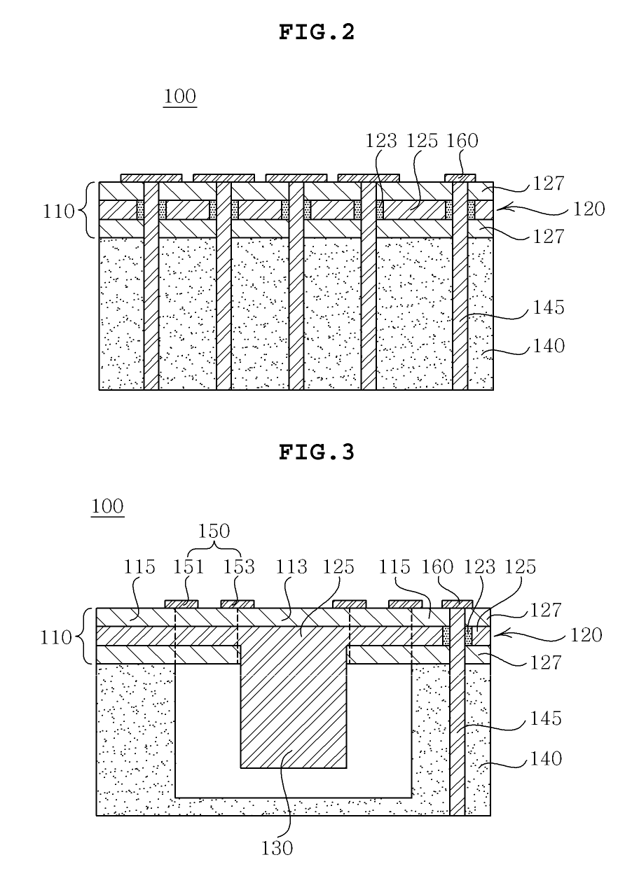

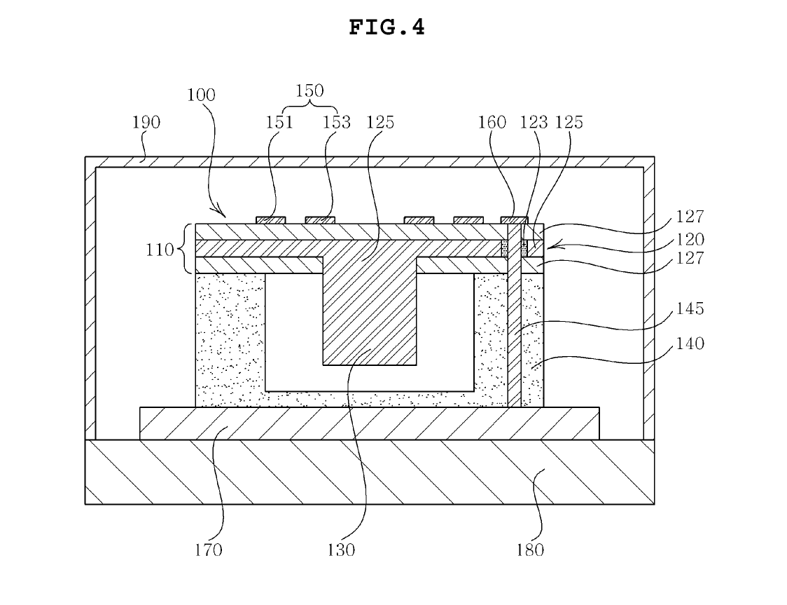

FIG. 1 is a plan view of an inertial sensor according to a first preferred embodiment of the present invention, FIG. 2 is a cross-sectional view of the inertial sensor shown in FIG. 1 taken along line A-A′, FIG. 3 is a cross-sectional view of the inertial sensor shown in FIG. 1 taken along line B-B, and FIG. 4 is a cross-sectional view of the inertial sensor shown in FIG. 3 with which an integrated circuit, a printed circuit board, and a metal cap are combined.

As shown in FIGS. 1 to 4, an inertial sensor 100 according to a preferred embodiment of the present invention is configured to include a membrane 110 including wiring layers 120 that are partitioned into insulating regions 123 and conducting regions 125, a mass body 130 provided under a central portion 113 of the membrane 110, and a post 140 provided under an edge 115 of the to membrane 110 so as to support the membrane 110 and surrounding the mass body 130.

The membrane 110 is formed in a plate shape and has elasticity so as to vibrate the mass body 130. In this configuration, a boundary of the membrane 110 is not clearly differentiated, but as shown in FIG. 3, may be partitioned into the central portion 113 of the membrane 110 and the edge 115 disposed along an outside of the membrane 110. In this case, the bottom portion of the central portion 113 of the membrane 110 is provided with the mass body 130, such that the central portion 113 of the membrane 110 may be displaced in response to the motion of the mass body 130. In addition, the bottom portion of the edge 115 of the membrane 110 is provided with the post 140 to support the central portion 113 of the membrane 110. Meanwhile, since elastic deformation is made between the central portion 113 and the edge 115 of the membrane 110, a driving electrode 151 is disposed to drive the mass body 130 or a sensing electrode 153 is disposed to sense the displacement of the mass body 130. However, the driving electrode 151 and the sensing electrode 153 are not necessarily be disposed between the central portion 113 and the edge 115 of the membrane 110, but as shown in FIG. 3, a part thereof may be disposed at the central portion 113 or the edge 115 of the membrane 110.

In addition, the membrane 110 includes the wiring layers 120 that are partitioned into the insulating regions 123 and the conducting regions 125. A circuit necessary for the inertial sensor 100 may be implemented using the wiring layers 120. In this configuration, the wiring layers 120 may be partitioned into the insulating regions 123 and the conducting regions 125 by selectively anodizing, for example, a metal core by an anodizing process. The anodizing process immerses the metal core in an electrolytic solution such as boric acid, phosphoric acid, sulfuric acid, chromic acid, or the like, applies an anode to the metal core, and applies a cathode to the electrolytic solution, such that an anodized portion of the metal core becomes the insulating regions 123 and the non-anodized portion becomes the conducting regions 125. Further, the metal core is not particularly limited, but may be preferably formed of any one of aluminum (Al), nickel (Ni), magnesium (Mg), titanium (Ti), zinc (Zn), and tantalum (Ta). As such, since the membrane 110 is formed as the metal core rather than an SOI substrate, the total manufacturing cost of the inertial sensor 100 may be reduced and sensitivity of the inertial sensor 100 may be improved by reducing parasitic capacitance.

Additionally, both surfaces of the wiring layers 120 may be provided with insulating layers 127. In this case, the insulating layers 127 serve to prevent the conducting regions 125 of the wiring layers 120 and electrodes 150 from being short-circuited with each other while serving to protect the wiring layers 120. In this case, the insulating layers 127 may be formed by an oxidation or coating process, but are not necessarily formed by the process. Therefore, the insulating layers 127 may be formed by all the processes known to those skilled in the art.

Meanwhile, the membrane 110 may be provided with the electrode 150 as described above (see FIG. 1). Here, the electrode 150 includes the driving electrode 151 and the sensing electrode 153. In this case, the mass body 130 is driven or the displacement of the mass body 130 is sensed, on the basis of a piezoelectric type, a piezo-resistive type, a capacitive type. In this case, the driving electrode 151 and the sensing electrode 153 are each formed in an arc shape. In detail, when the membrane 110 is partitioned into an inner annular region 157 surrounding the center of the membrane 110 and an outer annular region 155 surrounding the inner annular region 157, the driving electrode 151 may be formed in the outer annular region 155 in an arc shape and the sensing electrode 157 may be formed in the inner annular region 157 in an arc shape (however, the sensing electrode may be formed in the outer annular region 155 and the driving electrode 151 may also be formed in the inner annular region 157. In this case, the driving electrode 151 may divided into N and the sensing electrode 153 may be divided into M. In the drawings, the driving electrode 151 and the sensing electrode 153 are each divided into four, but the number of driving electrodes 151 and sensing electrodes 153 may be arbitrarily determined in consideration of the manufacturing costs and the sensitivity to be implemented. Meanwhile, the driving electrode 151 and the sensing electrode 153 may be formed by sputtering, evaporation deposition, or the like. Here, the sputtering is a method for to forming the electrode 150 by making vapor particles by a physical method and depositing them to the membrane 110 and the evaporation deposition is a method for forming the electrode 150 by evaporating or sublimating materials and depositing them to the membrane 110 in an atom or molecule unit.

Further, the driving electrode 151 and the sensing electrode 153 are electrically connected to pads 160 formed at the edge 115 of the membrane 110 through connection patterns 165. In this case, the pads 160 are electrically connected to through holes 145 penetrating through the membrane 110 and the post 140 (see FIGS. 2 and 3), wherein the through holes 145 are electrically connected to an integrated circuit 170 provided under the post 140 (see FIG. 4). Consequently, the pads 160 are electrically connected to the integrated circuit 170 through the through holes 145. Here, the through holes 145 may be formed by machining holes using deep reactive-ion etching (DRIE) or laser and then, plating copper or depositing tungsten. Unlike the inertial sensor according to the prior art, the inertial sensor 100 according to the preferred embodiment of the present invention connects the pads 160 to the integrated circuit 170 through the through holes 140 rather than wire bonding, thereby making it possible to manufacture the inertial sensor 100 having a relatively simple structure. As a result, a thickness of the inertial sensor 100 can be reduced, thereby making it possible to implement the inertial sensor 100 in a thin type and reduce noise. Meanwhile, as shown in FIG. 3, in order to prevent the through holes 145 and the conducting regions 125 from being short-circuited with each other, the through holes 145 may preferably pass through the insulating regions 123 of the membrane 110. However, the through holes 145 may be conducted with one another by penetrating through the conducting regions 125 of the membrane 110 according to the configuration of the circuit to be implemented.

The mass body 130 is displaced according to an action of inertial force or Coriolis force to measure acceleration or angular velocity and is provided under the central portion 113 of the membrane 110 (see FIG. 3). Here, the mass body 130 may be formed in, for example, a polyprism shape including a cylinder. Meanwhile, the mass body 130 may be formed by extending downwardly of the membrane 110 from the conducting regions 125. That is, the mass body 130 may be integrally formed with the conducting regions 125 by extending from the conducting regions 125 provided at the central portion 113 of the membrane 110. In this case, the conducting regions 125 are formed as the metal core and therefore, the mass body 130 is also formed of metal. Therefore, the sensitivity of the inertial sensor 100 can be improved by increasing a mass density of the mass body 130. Further, the mass body 130 is integrally formed with the conducting regions 125 and therefore, the coupling force between the mass body 130 and the membrane 110 is strengthened, thereby making it possible to previously prevent the mass body 130 from separating from the membrane 110 even though strong impact is applied to the inertial sensor 100.

The post 140 is formed in a hollow shape to support the membrane 110 so as to secure a space in which the mass body 130 may be displaced. The post 130 is disposed under the edge 115 of the membrane 110 (see FIG. 3). Here, the post 140 may be formed in a square pillar having a cylindrical cavity at a center thereof. Consequently, when being viewed from a transverse section, the mass body 130 is formed in a circular shape and the post 140 is formed in a square shape having a circular opening provided at the center thereof. In addition, the material of the post 140 is not particularly limited, but the post 140 may be preferably formed of silicon, polymer, or the like.

Meanwhile, as shown in FIG. 4, a printed circuit board 180 may be provided under the integrated circuit 170 and a metal cap 190 covering the inertial sensor 100 may be provided by extending upwardly from the edge of the printed circuit board 180 so as to protect the inertial sensor 100.

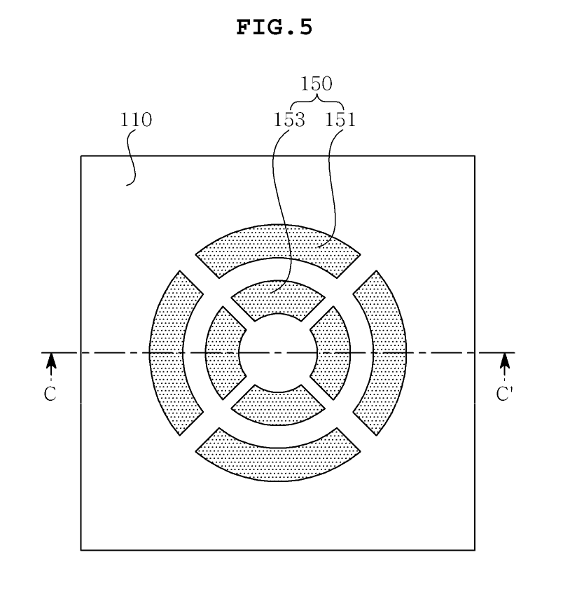

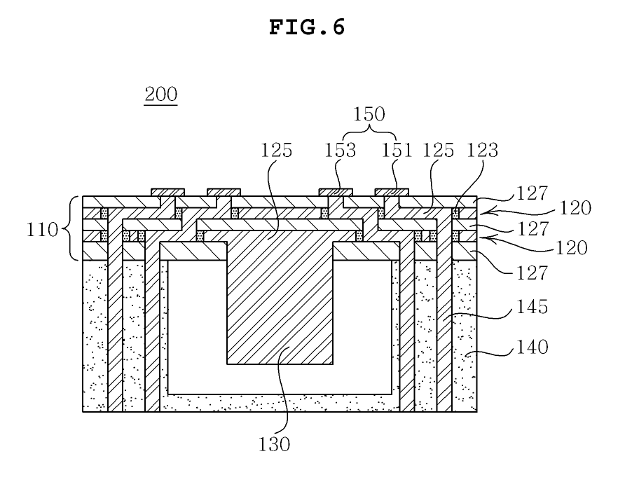

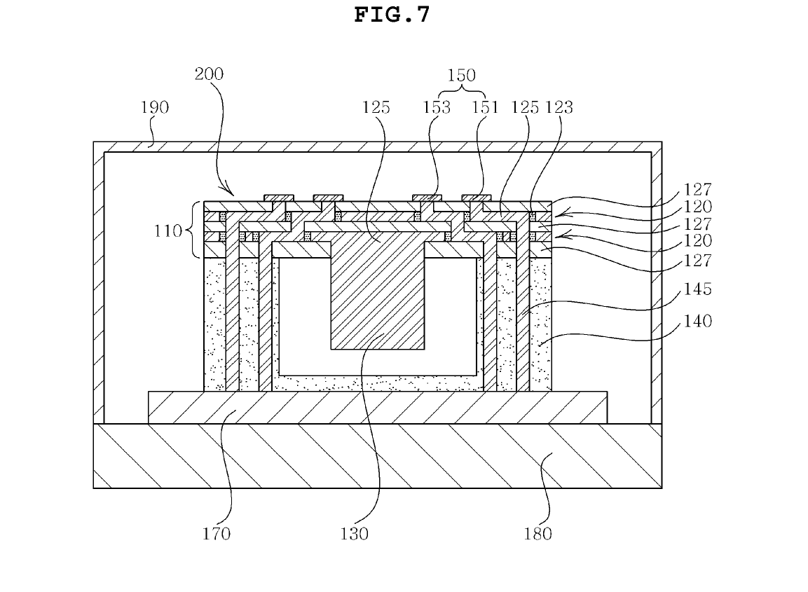

FIG. 5 is a plan view of an inertial sensor according to a second preferred embodiment of the present invention, FIG. 6 is a cross-sectional view of the inertial sensor shown in FIG. 5 taken along the line C-C′, and FIG. 7 is a cross-sectional view of the inertial sensor shown in FIG. 6 with which an integrated circuit, a printed circuit board, and a metal cap are combined.

As shown in FIGS. 5 to 7, the largest difference between an inertial sensor 200 according to the second preferred embodiment of the present invention and the inertial sensor 100 according to the first preferred embodiment of the present invention is the configuration of the wiring layers 200 and whether the pads 160 and the connection patterns 165 are present. Therefore, the inertial sensor 200 according to the second preferred embodiment is mainly describes with reference to the above difference and therefore, the description of the repeated portion with the inertial sensor 100 according to the first preferred embodiment will be omitted.

The membrane 110 of the inertial sensor 200 according to the preferred embodiment of the present invention includes the wiring layers 120 staked in a multi-layer. Therefore, the circuit necessary for the inertial sensor 200 may be implemented in a multi-layer using the wiring layers 120. In addition, a freedom of the circuit design may be increased by stacking the wiring layers 120 in a multi-layer. Therefore, the electrodes 150 may be electrically connected to the through holes 145 through the conducting regions 125 of the wiring layers 120 (see FIG. 6), without separately forming the pads 160 and connection patterns 165 on the membrane 110 (see FIG. 5). In addition, the electrodes 150 are connected to the through holes 145 through the wiring layers 120 of the membrane 110 and therefore, it is sufficient to penetrate the through holes 145 through only the post 140 without penetrating through the membrane 110. As shown in FIG. 7, the through holes 145 are electrically connected to the integrated circuit 170 provided under the post 140, such that the electrodes 150 are electrically connected to the integrated circuit 170 through the conducting regions 125 and the through holes 145.

As described above, the inertial sensor 200 according to the preferred embodiment of the present invention does not need to separately form the pads 160 and the connection patterns 165 on the membrane 110 since the conducting regions 125 serve as the pads 160 (FIG. 1) and the connection patterns 165. Therefore, it is possible to simplify the manufacturing process of the inertial sensor 200 and increase the electrical reliability between the electrodes 150 and the integrated circuit 170.

Meanwhile, the wiring layers 120 are stacked in a multi-layer and therefore, it is preferable to form the insulating layers 127 between the wiring layers 120 so as to insulate the wiring layers 120 stacked in a multi-layer from one another. In addition, similar to the inertial sensor 100 according to the first preferred embodiment of the present invention, it is preferable to form the insulating layers 127 at the outermost of the wiring layers 120.

According to the preferred embodiments of the present invention, the total manufacturing cost of the inertial sensor can be reduced by forming the membrane as the cheap metal core and the sensitivity of the inertial sensor can be improved by reducing the parasitic capacitance.

Further, according to the preferred embodiments of the present invention, the mass density of the mass body is increased by forming the mass body extending from the membrane as metals, thereby making it possible to improve the sensitivity of the inertial sensor.

In addition, according to the preferred embodiment of the present invention, the electrodes (the driving electrode and the sensing electrode) is connected to the integrated circuit through the wiring layers or the through holes of the membrane to manufacture the inertial sensor having a relatively simple structure, such that the thickness of the inertial sensor can be reduced, thereby making it possible to implement the inertial sensor in a thin type and reduce noise.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a membrane including wiring layers that are partitioned into insulating regions and conducting regions;
a mass body provided under a central portion of the membrane; and
a post provided under an edge of the membrane so as to support the membrane and surrounding the mass body.

2. The inertial sensor as set forth in claim 1, wherein the membrane is provided with electrodes and pads electrically connected to the electrodes and provided at the edge of the membrane, the pads being electrically connected to through holes penetrating through the membrane and the post.

3. The inertial sensor as set forth in claim 2, wherein the through holes penetrate through the insulating regions of the membrane.

4. The inertial sensor as set forth in claim 2, wherein a bottom portion of the post is provided with an integrated circuit and the through holes are connected to the integrated circuit.

5. The inertial sensor as set forth in claim 1, wherein the membrane is provided with electrodes and the electrodes are electrically connected to the through holes that penetrate through the post through the conducting region.

6. The inertial sensor as set forth in claim 5, wherein a bottom portion of the post is provided with an integrated circuit and the through holes are connected to the integrated circuit.

7. The inertial sensor as set forth in claim 1, wherein the conducting regions are made of metals and the mass body is formed by extending downwardly of the membrane from the conducting region.

8. The inertial sensor as set forth in claim 1, wherein both surfaces of the wiring layers are provided with insulating layers.

9. The inertial sensor as set forth in claim 1, wherein the wiring layers are stacked in a multi-layer and insulating layers are formed between the wiring layers stacked in a multi-layer.

10. The inertial sensor as set forth in claim 1, wherein the wiring layers are partitioned into the insulating regions and the conducting regions by selectively anodizing a metal core by an anodizing process.

11. The inertial sensor as set forth in claim 10, wherein the metal core is made of any one of aluminum (Al), nickel (Ni), magnesium (Mg), titanium (Ti), zinc (Zn), and tantalum (Ta).

12. The inertial sensor as set forth in claim 1, wherein the post is made of silicon or polymer.
